(19) United States
(12) Patent Application Publication
(10) Pub. No.: US 2002/0056378 A1
(43) Pub. Date: May 16, 2002

(54) Apparatus for printing golf tees

(76) Inventor: Frank Dorner, Wien (AT)

Correspondence Address: Flynn, Thiel, Boutell & Tanis, P.C., 2026 Rambling Road, Kalamazoo, MI, 49008-1699, US

(21) Appl. No.: 10/057,078

(22) Filed: Jan. 24, 2002

(30) Foreign Application Priority Data
Jan. 25, 2001 (DE) 101 03 343.5

(51) Int. Cl. B41F 17/00

(52) U.S. Cl. 101/35

(57) ABSTRACT

An apparatus for printing golf tees and similar nail-shaped objects has a rack (4) for forming a row of tees (2) with two rails (18, 19) on which the tees (2) rest with their heads (16) and between which they hang downward with their points (15), a conveying means (5) with an endless carrying device (21) having entrainers (22, 23) disposed side by side in pairs and spaced apart in the longitudinal direction of the carrying device (21) at a distance which is greater than the length of a tee (2), and a printing apparatus (6) for printing the tees (2) lying on the upper run (7) of the conveying means carrying device (21), the turning end (24) of the conveying means (5) being so disposed relative to the rack (4), and the conveying means (5) having such a circulating direction (25), that the particular entrainer pair (22, 23) at the turning end (24) is moved from the bottom to the top between the rails (18, 19) to engage under the head (16) of the foremost tee (2) of the row facing the turning end (24) and place it during its further transport to the printing apparatus (6) on the upper run (7).

This invention relates to an apparatus for printing golf tees and the like.

Golf tees are the pegs on which golf balls are placed to be struck at the beginning of play. A tee has a shaft with a point which is set into the earth, and a usually flaring head with a depression in which the golf ball is placed. Tees are usually made of wood or plastic. Further details on golf tees can be found on the web site www.randa.org.

Tees are frequently provided with advertising and similar prints. This is generally done using ink dabber printing, for which an elaborate block must be produced, so that it is only suitable for large series.

However, there is also a need to print tees with the name of a company, the name of the particular golfer or the like, i.e. in a small piece number with frequently changing texts.

The problem of the invention is therefore to provide a simply constructed, easily operated, efficient apparatus for printing golf tees.

This is obtained according to the invention by the apparatus characterized in claim 1. The subclaims state advantageous embodiments of the inventive apparatus.

According to the invention a rack for forming a row of tees is thus provided. The lined-up tees are suspended between two rails which form a longitudinal slit. The distance between the rails, or the width of said slit, is greater than the diameter of the shaft but smaller than the diameter of the head of the tee, so that the shaft of the tee hangs downward with the point through the slit or between the rails, while the head of the tee rests on both rails or the side edges of the slit.

The conveying means preferably used is a belt or chain conveyor, i.e. the carrying or traction device of the conveying means is formed by a band or belt or one or more chains.

Entrainers are disposed in pairs on the carrying device at a distance in the longitudinal or conveying direction which is greater than the length of a tee, so that the tees can be deposited on the carrying device at a distance apart in the longitudinal direction.

The entrainers of each pair are at a distance apart which is greater than the diameter of the shaft of the tee but smaller than the diameter of its head.

The turning end of the conveying means is so disposed relative to the rack, and the conveying means has such a circulating direction, that the particular entrainer pair at the turning end is moved from the bottom to the top between the rails of the rack to engage under the head of the foremost tee of the row facing the turning end and place it during its further transport to the printing apparatus on the upper run, i.e. the upper section of the conveying means.

The turning end can be formed by a deflection roller for example in a belt conveyor, or a guide wheel, for example a guide gearwheel, e.g. in a chain conveyor.

The preferred printing apparatus according to the invention is an ink jet printer since it firstly can readily print on round, nonplane surfaces, and secondly can be driven individually and easily with a PC or similar data processing system. That is, the invention permits even very small series to be printed in simple fashion, if desired each tee differently.

The slanted arrangement of the rails of the rack, i.e. when their lower ends face the turning end of the conveying means, permits the rails of the rack to be formed as a chute.

At the end of the rails of the rack facing the turning end of the conveying means, a stop is provided for the foremost tee. Said stop can be formed e.g. by bending up the ends of the rails or the like. It is only essential that the stop not prevent the foremost tee of the rack from being received by the particular entrainer pair of the conveying means.

For each tee to be positioned precisely under the printing apparatus, the conveying means is preferably formed by a belt or at least one chain on which links are fastened from which the entrainers protrude, on the one hand, and which each have a depression, on the other hand, so that they form a channel extending in the longitudinal conveying direction on the upper run of the conveying means. The depressions can be of V shape in cross section. Additionally, they can also be formed with different heights in the longitudinal direction. This causes the tees to be disposed in the middle or in a defined position in the longitudinal direction as well as horizontally in the optimal printing plane, based on the width of the traction device.

Furthermore, for exact positioning of the tees under the printing apparatus a presser is provided between the turning end and the printing apparatus for lightly pressing the tees so that tees whose heads are not lying against the entrainer pair are pulled with their heads toward the entrainer pair. After that a sensor is mounted for reporting the presence of a tee and the start position for printing to the printing unit.

To permit automatic operation of the apparatus, a tee singling device is preferably provided from which the tees are supplied to the rack. The singling device may be formed as a bowl or similar vessel with a coil on the inside wall which rises upward from the bottom. The vessel is set in rotary vibrations about the center axis of the coil by a vibrating device such that the tees travel upward jerkily on the coil. The tees are thereby aligned in the longitudinal direction, i.e. tees not disposed in the longitudinal direction of the coil are either not received by the coil or drop off it again to the vessel bottom. Furthermore, a suitable installation (e.g. a taper of the coil) ensures that only one tee after the other is transported.

The vibrating device can have for example one or more electromagnets which attract the bowl contrary to the force of a spring, whereby when the electromagnet or electromagnets are turned off the springs abruptly turn the bowl a piece so that the tees are moved upward on the coil according to the law of inertia.

At the upper end of the coil two rails are preferably fastened side by side for moving the tees to the rack. The rails of the supply device are preferably disposed on a slant in order to form a chute for the tees to the rack. Said rails simultaneously cause the tees to be all suspended in identical alignment with their heads upward, no matter in which direction they arrive at the end of the coil.

A sensor is preferably provided on the rack for switching off or stopping the singling device at a predetermined number of tees in the rack, and switching it on again when there is less than a predetermined number of tees. The rack is mechanically unconnected with the singler so that no vibration of the vibrating conveyor is transmitted to the rack and the conveying device.

The inventive apparatus has been conceived primarily for golf tees. However, it can be used equally well for printing other nail-like, cylindrical, conic or similar elongate objects, e.g. prismatic elongate objects such as pencils. If no suitably formed head of the tee or object to be printed is available, another inventive embodiment is provided such that the alignment is effected by suitable installations in the vibrating conveyor. The objects thus already aligned can then be supplied on a chute in the form of a channel likewise to the conveyer belt, in this case on the upper run area.

In the following an example of the invention will be explained in more detail with reference to the drawing, in which:

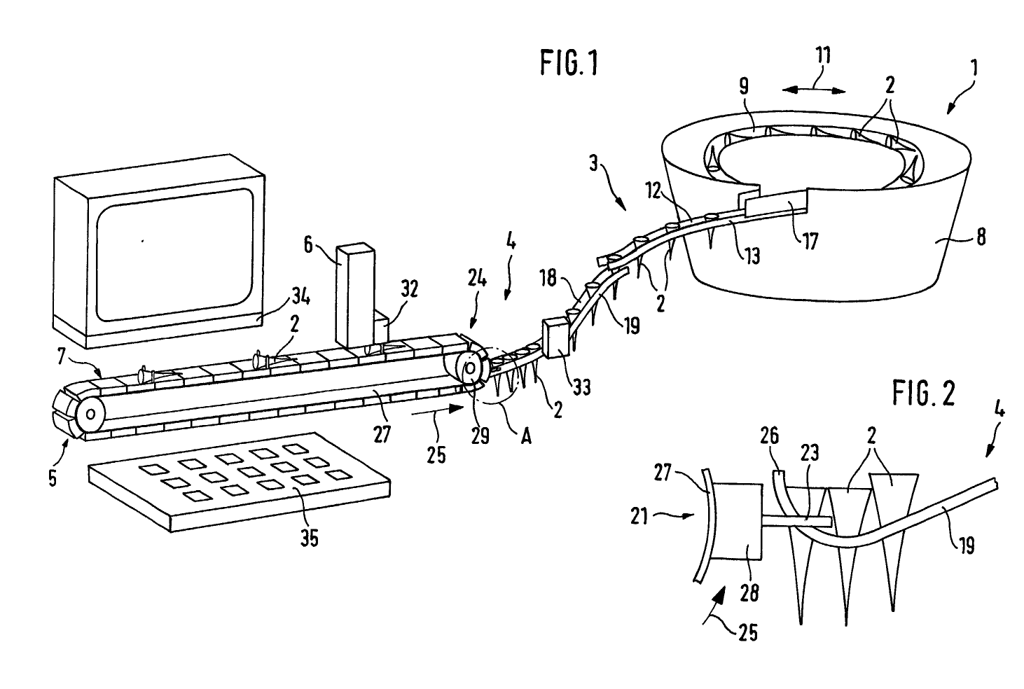

FIG. 1 shows a perspective view of the apparatus;

FIG. 2 shows an enlarged view of area A in FIG. 1 in a side view; and

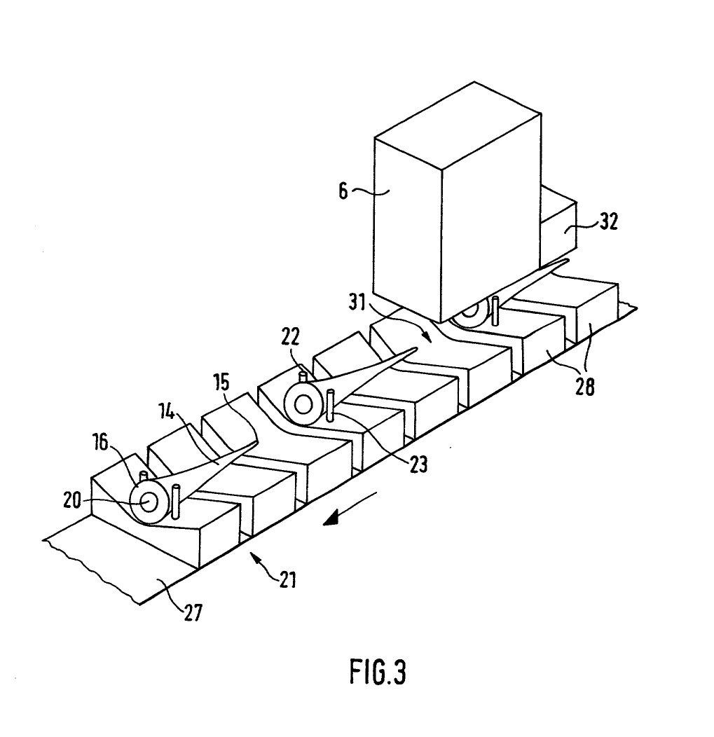

FIG. 3 shows a perspective view of a part of the upper run or section of the conveying means.

The apparatus has singling device 1 for tees 2, supply device 3 for supplying tees 2 from singling device 1 to rack 4, circulating, endless conveying means 5 and printing apparatus 6 above upper section or run 7 of conveying means 5.

Tee singling device 1 has bowl-shaped vessel 8 containing an invisible supply of tees 2 to be singled. On the inside wall of vessel 8 there is coil 9 having one to two turns and rising upward from the bottom of vessel 8 to supply device 3. Vessel 8 with coil 9 is set by a vibrating device (not shown) in rotary vibrations according to arrow 11 such that tees 2 on coil 9 travel upward jerkily lying in the longitudinal direction of the coil. The coil tapers at a point in the upper area such that only one tee after the other can pass said point. If two tees arrive in this area simultaneously, one of them is thrown off again.

Supply device 3 has two rails 12, 13 which are fastened to bowl 8 at the upper end of coil 9. As indicated in particular by FIG. 3, each tee 2 consists of cylindrical or slightly conic shaft 14 with point 15 whose upper end flares to head 16 with depression 20. When foremost tee 2 facing rails 12, 13 on coil 9 leaves coil 9 during further transport (regardless of whether it arrives head or point first), head 16 of said tee 2 is caught by the two rails 12, 13. This process is supported by guide surfaces 17 which are fastened to vessel 8 and extend from the upper end of the coil in the direction of rails 12, 13 on both sides thereof.

Rails 12, 13 extend on a slant downward from the upper end of the coil to rack 4, thereby forming a chute.

Rack 4 has two rails 18, 19 lying side by side to form a row of tees 2. Tees 2 rest with their heads 16 on rails 18, 19 so that they hang downward with their points 15 between rails 18, 19.

Rails 12, 13 of supply device 3 fastened to vessel 8 extend over rails 18, 19 of rack 4, in such a way that tees 2 dropping down at the end of rails 12, 13 are caught with their heads 16 by rails 18, 19 of rack 4.

The distance of rails 12, 13 of supply device 3 from rails 18, 19 of rack 4 in the vertical direction is substantially smaller than the length of shaft 14 with point 15 of tee 2, so that shaft 14 of tee 2 is moved on rails 12, 13 between rails 18, 19 of rack 4 before tee 2 drops down from rails 12, 13 of supply device 3 onto rails 18, 19 of rack 4. The upper end of rails 18, 19 of rack 4, i.e. the end facing singling device 1, and/or the lower end of rails 12, 13 of supply device 3 facing conveying means 5 can widen in a funnel shape for receiving shaft 14 or for dropping tees 2 onto rails 18, 19 of rack 4.

Conveying means 5 has carrying device 21 which is provided with entrainers 22, 23 disposed side by side in pairs (FIG. 3). Entrainer pairs 22, 23 are disposed at a distance in the longitudinal direction of carrying device 21 which is greater than the length of one tee 2.

Rails 18, 19 of rack 4 are disposed on a slant in order to form a chute for lined-up tees 2.

Turning end 24 is disposed opposite the lower end of rails 18, 19 of rack 4. Carrying device 21 of conveying means 5 has the circulating direction indicated by arrow 25. Entrainers 22, 23 of each pair, which can be formed as fingers or pins, are at a distance apart which is smaller than the diameter of head 16 of tee 2 but greater than the diameter of shaft 14. The outsides of entrainers 22, 23 are so spaced, or the end of rails 18, 19 so tapered, that end 26 of rails 18, 19 fits between the entrainers when the entrainers are moved from the bottom to the top according to circulating direction 25 outside rails 18, 19 to engage under head 16 of foremost tee 2 of the row (FIG. 2). Tee 2 is then placed during its further transport in circulating direction 25 to printing apparatus 6 onto upper run 7 of carrying device 21.

Lower end 26 of rails 18, 19 of rack 4 is tapered and interconnected in order to form a stop for foremost tee 2.

Conveying means carrying device 21 can be formed by belt 27 on which mutually articulated links 28 are fastened. Turning end 24 of carrying device 21 is formed by deflection roller 29 for belt 27. At a suitable point on the conveying device an incremental encoder is mounted for reporting the particular adjusted transport speed to the printing device and thus permitting adjustment of the printing speed for optimizing the printed image.

Links 28 from which pin-shaped entrainers 22, 23 protrude are provided in the middle with V-shaped depressions 31, thereby forming on upper run 7 a channel extending in the conveying direction in which tees 2 lie. The channel has a depression in the area of the head of the tee in order to obtain a printing plane as flat as possible on the basically conic tee shaft.

Between turning end 24 or deflection roller 29 and printing apparatus 6 there is provided presser 32 in the form of a brush which presses on tees 2 so that tee 2 lying with its head 16 too far in front is slowed down and thus pulled with its head 16 onto particular entrainer pair 22, 23. Immediately after that, a sensor is also mounted for checking the presence of a tee as well as its position and reporting this to the printing unit.

Further sensor 33, for example a light barrier, is provided on the area of rack 4 facing away from conveying means 5. Sensor 33 detects when a predetermined number of tees 2 is located on rack 4. Sensor 33 then stops the vibrating device of singling device 1 and switches it on again as soon as there is less than the predetermined number of tees 2 again on rack 4.

Printing apparatus 6 is formed by an ink jet printer which is driven with PC 34 with a screen and keyboard 35.

1. An apparatus for printing golf tees and similar nail-shaped or conic or cylindrical objects, characterized by a rack (4) for forming a row of tees or similar objects (2) with two rails (18, 19) on which the tees or similar objects (2) rest with their heads (16) and between which they hang downward with their points (15), a conveying means (5) with an endless carrying device (21) having entrainers (22, 23) disposed side by side in pairs and spaced apart in the longitudinal direction of the carrying device (21) at a distance which is greater than the length of a tee or similar object (2), and a printing apparatus (6) for printing the tees (2) lying on the upper run (7) of the conveying means carrying device (21), the turning end (24) of the conveying means (5) being so disposed relative to the rack (4), and the conveying means (5) having such a circulating direction (25), that the particular entrainer pair (22, 23) at the turning end (24) is moved from the bottom to the top between the rails (18, 19) to engage under the head (16) of the foremost tee or similar object (2) of the row facing the turning end (24) and place it during its further transport to the printing apparatus (6) on the upper run (7).

2. An apparatus according to claim 1, characterized in that the printing apparatus (6) is an ink jet printer.

3. An apparatus according to claim 2, characterized in that the ink jet printer (6) is adapted to be driven with a PC (33) with a keyboard (34).

4. An apparatus according to claim 1, characterized in that the rails (18, 19) of the rack (4) are disposed on a slant to form a chute for the lined-up tees or similar objects (2) toward the turning end (24) of the conveying means (5).

5. An apparatus according to claim 1 or 4, characterized in that a stop for the foremost tee or similar object (2) is provided at the end (26) of the rails (18, 19) facing the turning end (24).

6. An apparatus according to claim 1, characterized in that the conveying means carrying device (21) has links (28) fastened thereto from which the entrainers (22, 23) protrude and which have a depression (31) to form on the upper run (7) of the conveying means (5) a channel extending in the conveying direction (25) for receiving the tees or similar objects (2).

7. An apparatus according to any of the above claims, characterized in that a tee singling device (1) is provided from which the tees or similar objects (2) are supplied to the rack (4).

8. An apparatus according to claim 7, characterized in that a device (3) for supplying the tees or similar objects (2) from the singling device (1) to the rack (4) is provided which has two rails (12, 13) on which the tees or similar objects (2) rest with their heads (16) and between which they hang downward with their points (15), the rails (12, 13) extending over the rails (18, 19) of the rack (4) such that the tees leaving the rails (12, 13) of the supply device (3) are received with their heads (16) by the rails (18, 19) of the rack (4).

9. An apparatus according to claim 7, characterized in that the tee singling device (1) is formed by a vessel (8) with a coil (9) rising from the bottom and a vibrating device which sets the vessel (8) in oscillating rotary vibrations (11) such that the tees or similar objects (2) on the coil (9) jerkily travel upward lying in the coil direction.

10. An apparatus according to claims 7 and 8, characterized in that the two rails (12, 13) of the supply device (3) are fastened to the upper end of the coil (9) such that the foremost tee or similar object (2) facing the rails (12, 13) on the coil (9) is caught during its further transport from the coil (9) with its head (16) by the two rails (12, 13) of the supply device (3).

11. An apparatus according to claim 8 or 10, characterized in that the rails (12, 13) of the supply device (3) are disposed on a slant to form a chute for the tees or similar objects (2) in the direction of the rack (4).

12. An apparatus according to any of the above claims, characterized in that a sensor (33) is provided which stops the singling device (1) at a predetermined number of tees or similar objects (2) on the rack (4) and starts the singling device (1) again at a predetermined smaller number of tees or similar objects (2) on the rack (4).

13. An apparatus according to any of the above claims, characterized in that a presser (32) is provided between the turning end (24) and the printing apparatus (6) for pressing on the tees or similar objects (2) such that a tee or similar object (2) whose head is not lying against the associated entrainer pair (22, 23) is pulled with its head (16) toward the entrainer pair (22, 23).

14. An apparatus according to any of the above claims, characterized in that the alignment of the tees or similar objects (2) to be printed is effected by installations in the vibrating conveyor.

15. An apparatus according to claim 14, characterized in that the supply device for the aligned tees or similar objects (2) has a wedge-shaped chute instead of rails.
